(19) United States
(12) Patent Application Publication
(10) Pub. No.: US 2015/0135662 A1
(43) Pub. Date: May 21, 2015

(54) Apparatus for Coalescing Particles of a First Fluid Entrained in a Flow of a Second Fluid

(71) Applicant: Nifco UK Ltd., Stockton-on-Tees (GB)

(72) Inventor: Paul Chapman, Stokesley (GB)

(21) Appl. No.: 14/543,056

(22) Filed: Nov. 17, 2014

(30) Foreign Application Priority Data
Nov. 18, 2013 (GB) 1320305.4

(51) Int. Cl. B01D 45/08; F01M 13/04; B04C 3/06

(52) U.S. Cl. CPC B01D 45/08; B04C 3/06; F01M 13/04; F01M 2013/0433
USPC 55/460; 55/464

(57) ABSTRACT

An apparatus 50 for coalescing particles of a first fluid entrained in a flow of a second fluid is described. Apparatus 50 comprises a housing 52 and an enclosure 54 formed in the housing, the enclosure 54 defining a longitudinal axis x-x. The enclosure 54 has at least one curved wall 56 arranged to direct fluid flow along the curved wall 56 in a curved path. A first inlet duct 60 is provided at a first location along the longitudinal axis x-x for enabling introduction of a fluid flow substantially along a tangent to the curved wall 56. The first inlet duct 60 defines a first channel 58 along which fluid flow is directed. The first channel has a decreasing cross-sectional area along the direction of fluid flow shown by arrow Y. An outlet 62 from the enclosure 54 is provided at a second location along the longitudinal axis x-x.

### CROSS-REFERENCE TO RELATED APPLICATIONS

This application claims benefit to United Kingdom Patent Application No. 1320305.4 filed Nov. 18, 2013, the disclosure of which is hereby incorporated by reference for all purposes.

### STATEMENT CONCERNING FEDERALLY SPONSORED RESEARCH OR DEVELOPMENT

Not applicable.

### FIELD OF THE INVENTION

The present invention relates to an apparatus for coalescing particles of a first fluid entrained in a flow of a second fluid, wherein the first fluid has a higher density than the second fluid, and to an assembly and apparatus for separating particles of the first fluid entrained in a flow of the second fluid out of the flow of the second fluid. The invention relates particularly, but not exclusively, to an apparatus and assembly for coalescing and separating particles of oil dispersed in blow-by gases in internal combustion engines.

### BACKGROUND OF THE INVENTION

Internal combustion engines are governed by legislation which limits the emission of hydrocarbons and other derivatives of the combustion process to the atmosphere. One of the problems faced by manufacturers of internal combustion engines is how to manage the gases that leak past the pistons into the crankcase whilst the engine is running These gases, which are known as blow-by gases, must be ventilated from the crankcase to prevent pressure build up. However, some legislation also requires that the blow-by gases are recycled into the inlet manifold of the engine.

This can be undesirable because the blow-by gases collect oil particles from the piston rings, crank bearings, and windage from the crank. As much as possible of this oil needs to be removed from the blow-by gases before it enters the inlet manifold. Excess oil passed to the inlet manifold will cause unacceptable exhaust emissions, fouling of the inlet valve and increased engine oil consumption. Consequently, oil separators are required to separate oil particles dispersed in blow-by gases.

Referring to FIG. 1, a known type of oil separator is shown connected to the crankcase 2 of a cylinder of an internal combustion engine. Crankcase 2 comprises an oil sump 4 in which oil is held to lubricate the engine. Blow-by combustion gases leak past the piston 6 in the direction of arrow A. However, the pressure in crankcase 2 must be kept at or below atmospheric pressure and the crankcase therefore must be ventilated to enable the blow-by gases to escape. Consequently, the crankcase is ventilated by passage 8. An oil separator chamber 10 is connected to passage 8 such that blow-by gases enter separator chamber 10 in the direction of arrow B.

The oil can separate by simply falling out of the air under gravity. Alternatively, several baffles (not shown) may be provided in chamber 10 to enable the oil to impinge on the baffles to collect and then fall off. The oil then either returns to sump 4 or is collected in a separate reservoir. Separator chamber 10 has an outlet 12 leading back to inlet manifold 14 of the cylinder. Consequently, some of the oil is removed in chamber 10 such that air re-entering the inlet manifold 14 is suitable for use in combustion.

The oil separator shown in FIG. 1 suffers from the following drawbacks. Simply feeding blow-by gasses into a chamber and allowing oil to separate under gravity is not particularly efficient and increasingly tight emissions regulations mean that oil separators need to be made more efficient and remove a greater proportion of the oil. On the other hand, commercial and market demands mean that the manufacturing cost must be minimised. Also, there is a significant amount of oil in the form of very fine particles in the range of 1 to 2 microns and these are very difficult to remove from air flow. In the example of FIG. 1, this type of oil separator has been found to be effective only in removing particles having a size greater than 5 microns which is not sufficient.

Referring to FIG. 2, another type of known separator is a cyclone 20. Cyclone 20 comprises an inlet port 22 into which air is passed into a cyclone chamber 24. The air circulates and falls and oil drops are deposited by centrifugal force onto the walls of the chamber 24. Larger particles of oil also fall out under gravity. The oil collecting in the chamber is removed by a drain 26 having baffles 28 at the bottom of the chamber. Clean air rises in the manner of a vortex to an outlet 30.

Cyclones such as the example shown in FIG. 2 can be effective removing oil particles having a diameter of approximately two microns. However, such cyclones suffer from the following drawbacks. It is known that if you have a plurality of small cyclones, they will be more effective at separating smaller particles than a single large cyclone for the same pressure drop and air flow rate. However, designing and manufacturing multiple cyclones each with an inlet, outlet and drain can be complex and expensive. They can also be difficult to fit into the available space in an engine. For cost reasons, an oil separator is often incorporated into the cam cover. This means that the separator should ideally require relatively little height and fit in a shallow cubic volume. However, cyclones do not typically conform to this requirement.

U.S. 2003/0057151 describes a multicell cyclone having axial gas outlets.

Further examples of cyclonic separators for separating solids from gas and having axial gas outlets are described in U.S. Pat. No. 6,110,242 and WO00/49933. The cyclonic separators described in these documents have axial gas outlets to enable cleaned gas to exit. If the gas exits tangentially with the dust or other solids, the separation would not be accomplished.

EP1747054 describes an alternative to a cyclone. A separation device is described having flow-through tubes in which what are called worm like elements are disposed. In each flow path, a worm like element having an anti-clockwise pitch is arranged next to a worm like element having a clockwise pitch. The worm like elements are therefore arranged to twist the flow of air passing through the flow path 90 degrees in one direction and then twist the air flow 90 degrees in the other direction. The reversal of the rotation of air is intended to separate oil droplets from the air and coalesce oil droplets into larger particles which are then separated by a downstream separator and baffle plates.

The apparatus of EP1747054 suffers from the following drawbacks. In some circumstances, by causing quick reversal of a flow of air between the clockwise and anti-clockwise worm like elements, turbulence can be caused which tends to keep oil entrained in the air flow rather than separating the oil. The worm like elements can also cause a pressure drop which is undesirable. Finally, moulding small features like the worm like elements can be difficult.

Another solution to the above mentioned problems is proposed in U.S. Pat. No. 6,860,915. A three-stage separator is described for separating oil droplets from blow-by gases. The first stage is a preliminary separator which is simply a chamber with baffle plates. The second stage is a helical tube through which air flows in a helical path to cause oil droplets to impinge on the outer surface of the path. The third stage is a filter element.

The apparatus of U.S. Pat. No. 6,860,915 suffers from the drawbacks that it is complicated to manufacture and also requires a filter. The use of a filter is always undesirable because the filter becomes clogged and requires periodic replacement.

EP1767276 describes a cyclone apparatus having a preliminary swirling chamber used to accumulate powdered and granular solid debris before it is passed into a cyclone chamber for separation. This apparatus suffers from the drawback of having large dimensions and low efficiency which make it unable to be used for separation of oil from blow-by gasses in internal combustion engines.

WO2011/067336 describes a separation system for separating oil from a flow of gas in an internal combustion engine. The system comprises a plurality of small coalescing apparatuses which feed gas flow into a larger cyclonic separation chamber. It is desirable to improve the coalescing efficiency of this apparatus and also remove the requirement for a cyclonic chamber.

GB1232373 describes a guide housing for a flow of air having dust or fibres entrained therein used in apparatus to separate dust and fibres from airflow in textile machinery. This apparatus is designed to separate solid particles from gas rather than coalesce liquid droplets entrained in gas flow. One embodiment has a single small inlet which direct air around a curved surface and a larger outlet arranged opposite to the direction of fluid flow. This arrangement is detrimental to the rotational velocity of fluid flow and increases pressure drop for a given flow rate. As a result, this apparatus could not be used unsuitable to coalesce droplets of liquid flowing in gas.

Another embodiment of GB1232373 uses a cylindrical filter arranged between the flow volume and a clean air outlet. Use of a filter to separate oil droplets from gas flow in an internal combustion engine is highly undesirable because the filter would require frequent changing which would mean continual maintenance on the vehicle engine. This embodiment could also therefore not be used to coalesce droplets of liquid flowing in gas.

Preferred embodiments of the present invention seek to overcome the above disadvantages of the prior art.

### SUMMARY OF THE INVENTION

According to an aspect of the present invention, there is provided an apparatus for coalescing particles of a first fluid entrained in a flow of a second fluid, wherein the first fluid has a higher density than the second fluid, the apparatus comprising:

a housing;

an enclosure formed in the housing, the enclosure defining a longitudinal axis and having at least one curved wall arranged to direct fluid flow along at least one said curved wall in a curved path;

a first inlet duct to the enclosure provided at a first location along the longitudinal axis for enabling introduction of a fluid flow substantially along a tangent to at least one said curved wall, the first inlet duct defining a first channel along which fluid flow is directed, the first channel having a decreasing cross sectional area along the direction of fluid flow;

an outlet from the enclosure provided at a second location along the longitudinal axis, remote from the first location, for enabling exit of the fluid flow substantially along a tangent to at least one said curved wall, wherein the enclosure is arranged to direct fluid flow along the at least one curved wall between an end of the first inlet duct disposed in the enclosure and the outlet to cause particles of the first fluid to coalesce and exit the outlet.

By providing a first inlet duct to the enclosure which defines a first channel having a decreasing cross-sectional area along the direction of fluid flow, this provides the advantage of reducing turbulence in fluid flow entering the enclosure and ensuring that fluid flow follows a tangential path into the enclosure. Reducing turbulence and improving tangential and laminar flow into the enclosure minimises pressure drop and improves the amount to which particles of the first fluid are coalesced into larger particles and droplets.

As a result, since the mass of fluid in a droplet is proportional to the cube of the radius of the droplet, increasing the droplet size of coalesced particles substantially increases the amount of fluid mass in the coalesced droplets. Larger droplets are easier to remove from fluid flow so increasing droplet size both simplifies removal of fluid from gas flow and significantly increases the amount of fluid mass removed from the gas flow.

In a preferred embodiment, the apparatus further comprises:

a second inlet duct to the enclosure provided at a third location along the longitudinal axis for enabling introduction of a fluid flow substantially along a tangent to at least one said curved wall, the second inlet duct defining a second channel along which fluid flow is directed, the second channel having a decreasing cross sectional area along the direction of fluid flow;

wherein the outlet from the enclosure is provided at the second location along the longitudinal axis for exit of all fluid flowing in the enclosure substantially along a tangent to at least one said curved wall and the second location is between the first and third locations; and

wherein the enclosure is arranged to direct fluid flow along the at least one curved wall between the end of the first inlet duct disposed in the enclosure and the outlet and an end of the second inlet duct disposed in the enclosure and the outlet to cause particles of the first fluid to coalesce and exit the outlet.

This provides the advantage of doubling the amount of fluid that can be processed for coalescing in the enclosure. If this apparatus is used in an internal combustion engine of a motor vehicle, oil separation apparatuses in modern internal combustion engines are generally formed from injection moulded plastics material and it has been found that it is straightforward to injection mould a coalescing apparatus having two inlet ducts and a single outlet at little additional cost than injection moulding a single inlet duct and outlet. This therefore provides the advantage of improving the coalescing function of the apparatus when formed by injection moulding at little additional cost.

The outlet may be located at the mid-point between the ends of the first and second inlet ducts disposed in the enclosure along the first longitudinal axis.

A portion of at least one said curved wall may be substantially cylindrical.

This has been found to be a particularly effective enclosure cross-section for coalescing of fluid particles, which is also straightforward to manufacture by injection moulding.

In a preferred embodiment, said outlet is arranged tangentially in the direction of fluid flow along said curved wall.

By arranging both the inlets and outlet tangentially in the direction of fluid flow set up around the curved wall, this arrangement has been found to maximise fluid rotational velocity and minimises pressure drop in the apparatus.

According to another aspect of the present invention, there is provided an apparatus for coalescing particles of a first fluid entrained in a flow of a second fluid, wherein the first fluid has a higher density than the second fluid, the apparatus comprising a first apparatus as defined above mounted back-to-back with a second apparatus as defined above.

This provides the advantage of an apparatus that can be injection moulded at relatively low cost and which doubles the coalescing volume and capability of the apparatus.

According to a further aspect of the present invention, there is provided an assembly for separating particles of a first fluid entrained in a flow of a second fluid out of the flow of the second fluid, wherein the first fluid has a higher density than the second fluid, the assembly comprising:

a separation housing defining a separation chamber;

a plurality of ribs formed along a wall of said separation chamber; and

an apparatus as defined above arranged such that the outlet of the apparatus directs coalesced particles of the first fluid entrained in fluid flow of the second fluid to enter the separation chamber and impinge on the edges of said plurality of ribs to cause particles of said first fluid to be held between said plurality of ribs and be removed from said fluid flow of the second fluid.

This provides the advantage of an assembly which increases the amount of coalesced fluid particles that are removed from a flow of fluid exhausting from the outlet of the coalescing apparatus. It has been found that coalesced fluid particles such as oil droplets impact against and are retained between the plurality of ribs. The plurality of ribs provides a large surface area with grooves which retain and create a fluid coating to help entrap further fluid particles which make contact with the ribs. This therefore improves the separation efficiency of the assembly.

According to a further aspect of the present invention, there is provided an apparatus for separating particles of a first fluid entrained in a flow of a second fluid out of the flow of the second fluid, wherein the first fluid has a higher density than the second fluid, the apparatus comprising:

a separation housing defining a separation chamber; and

a plurality of ribs formed along a wall of said separation chamber, wherein said plurality of ribs is arranged such that coalesced particles of the first fluid entrained in fluid flow of the second fluid impinging on the edges of said plurality of ribs causes particles of said first fluid to be held between said plurality of ribs and be removed from the fluid flow of the second fluid.

It has been found that coalesced fluid particles such as oil droplets impact against and are retained between the plurality of ribs. The plurality of ribs provide a large surface area with grooves that retain and create a fluid coating which helps entrap further fluid particles which make contact with the ribs. This therefore improves separation of the first fluid from a flow of the second fluid.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

Preferred embodiments of the present invention will now be described, by way of example only, and not in any limitative sense, with reference to the accompanying drawings in which:

FIG. 1 is a cross-sectional view of a cylinder of an internal combustion engine comprising a prior art oil separator;

FIG. 2 is a cross-sectional view of a prior art cyclone oil separator;

FIG. 3 is a perspective view of an assembly for separating particles of a first fluid entrained in a flow of a second fluid out of the flow of the second fluid of an embodiment of the present invention and incorporating and apparatus for coalescing particles of the first fluid entrained in a flow of the second fluid of an embodiment of the present invention;

FIG. 4 is a cross-section of the assembly of FIG. 3 taken through the longitudinal axis x-x of the enclosure of the coalescing apparatus;

FIG. 5 is a cross-section of the assembly of FIG. 3 taken across the axis x-x of the enclosure of the coalescing apparatus; and

FIG. 6 is an exploded perspective view of the assembly of FIGS. 3 to 5 showing the separating apparatus.

### DETAILED DESCRIPTION OF THE PREFERRED EMBODIMENT

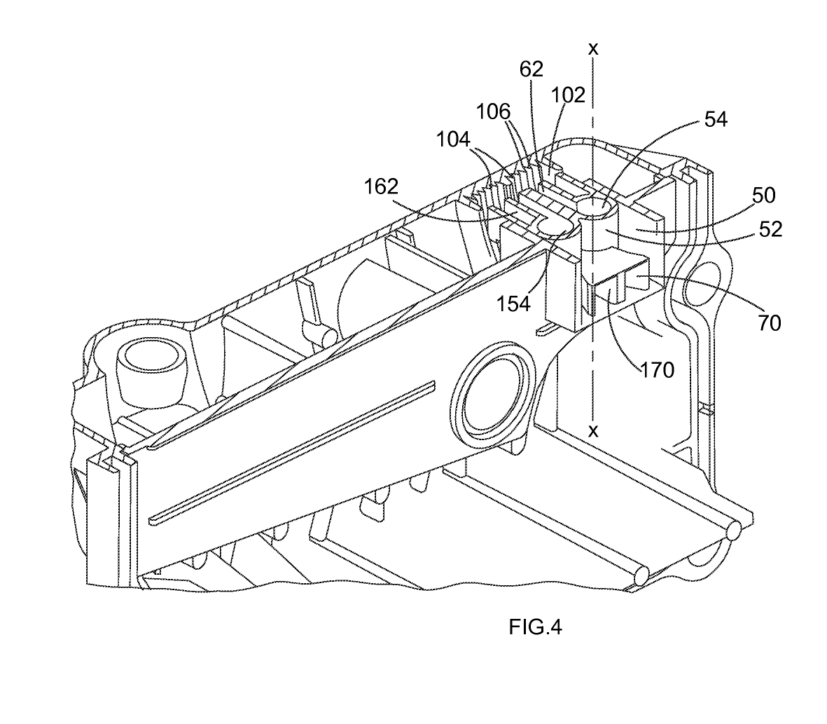

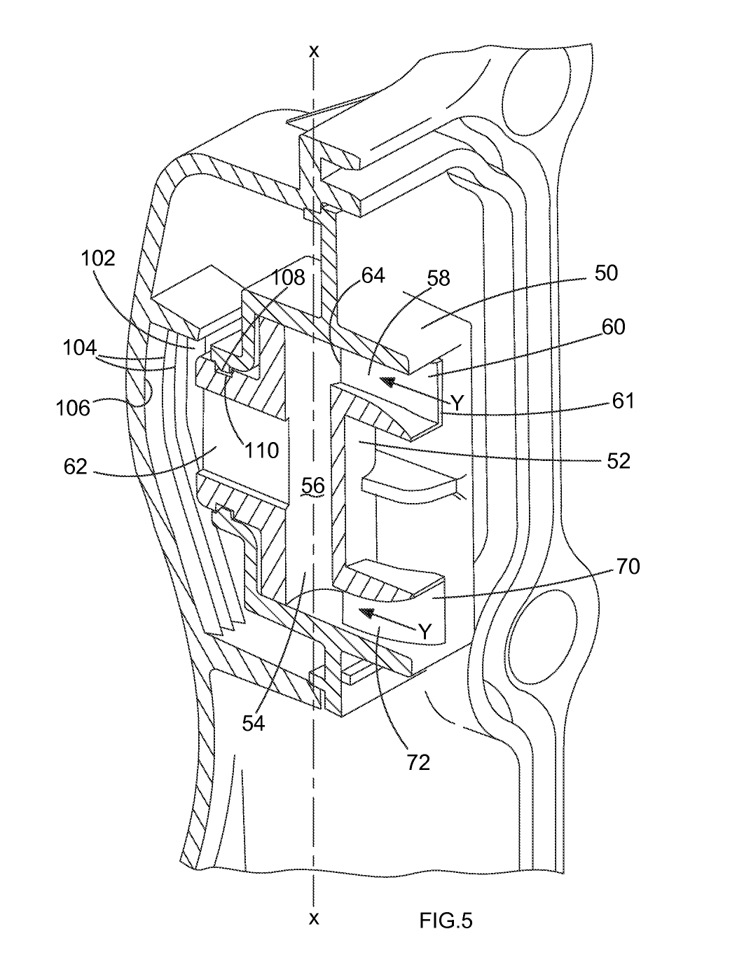

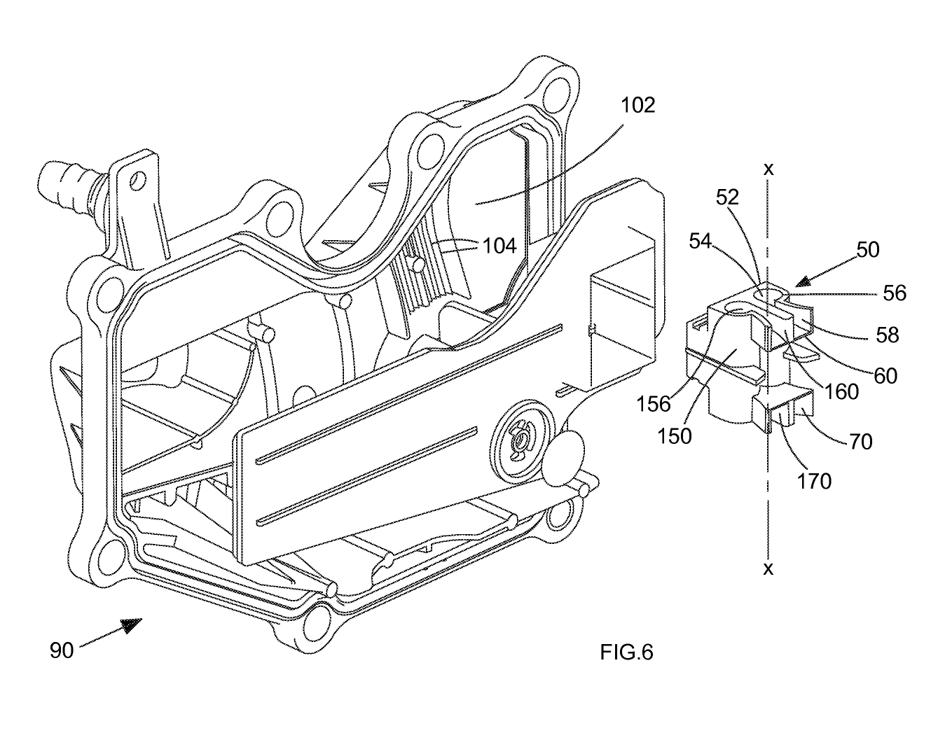

Referring to FIGS. 3 to 6, an apparatus 50 for coalescing particles of a first fluid entrained in a flow of a second fluid, wherein the first fluid has a higher density than the second fluid (neither fluid is shown in the drawings), comprises a housing 52 and an enclosure 54 formed in the housing, the enclosure 54 defining a longitudinal axis x-x. The enclosure 54 has at least one curved wall 56 arranged to direct fluid flow along the curved wall 56 in a curved path.

A first inlet duct 60 is provided at a first location along the longitudinal axis x-x for enabling introduction of a fluid flow substantially along a tangent to the curved wall 56. The first inlet duct 60 defines a first channel 58 along which fluid flow is directed. The first channel has a decreasing cross-sectional area along the direction of fluid flow shown by arrow Y. It can be seen that the first channel 58 is substantially trumpet-shaped in longitudinal cross-section with a decreasing cross-section both along and across its longitudinal axis from the opening 61 to the inner end 64 disposed in the enclosure 54.

An outlet 62 from the enclosure 54 is provided at a second location along the longitudinal axis x-x which is different to the first location defined by inner end 64 of inlet duct 60. The outlet 62 enables exit of fluid flow substantially along a tangent to the curved wall 56. The enclosure 54 is therefore arranged to direct fluid flow along the curved wall between inner end 64 of inlet duct 60 and the outlet 62 to cause particles of the first fluid to coalesce and exit outlet 62.

It has been found that a mixture of fluids, such as oil droplets entrained in a flow of air entering first inlet duct 60 is channelled by the first channel 58 to enter the enclosure 54 at a tangent to the curved wall 56. The curved wall 56 in the embodiment shown is substantially cylindrical, although other shapes such as conical enclosures could be used. The reducing cross-sectional area of channel 58 guides fluid flow to reduce turbulence and provide a laminar, tangential airflow into enclosure 54 and along curved wall 56. The spiralling action of the fluid flow along the curved wall 56 between end 64 of inlet duct 60 and outlet 62 causes droplets of oil to coalesce and exit outlet 62. This apparatus has been found to coalesce oil droplets smaller than 5 microns into droplets having a size large enough to be separated by impaction on a wall normal to the direction of fluid flow, or by another separation method.

A second inlet duct 70 to the enclosure 54 is provided at the opposite end to the first inlet duct 60. The second inlet duct 70 defines a second channel 72 which is also trumpet-like in cross-section with a reducing cross-sectional area along the direction of fluid flow Y. As a consequence, the outlet 62 is positioned between the first and second inlet ducts 60 and 70 and preferably at the midpoint. This provides two inlet ducts for airflow to increase the amount of fluid processed and coalesced in the enclosure 54. By providing two inlet ducts 60 and 70, it has been found that the manufacturing cost of this apparatus is not substantially increased yet the coalescing capability of the apparatus is doubled.

Outlet 62 is arranged tangentially in the direction of fluid flow Y along the curved wall 56. The rotational direction of fluid flow Y along the curved wall 56 is set up by the tangential orientation of inlet ducts 60 and 70. By arranging both the inlet ducts 60, 70 and outlet 62 tangentially in the direction of fluid flow Y, this arrangement has been found to maximise fluid rotational velocity and minimise pressure drop in the apparatus 50.

Referring to FIGS. 3, 4 and 6, a second coalescing apparatus 150 is mounded back-to-back with the first coalescing apparatus 50. Second coalescing apparatus has inlet ducts 160 and 170 and outlet 162 to double the volume of the apparatus and double the coalescing capability at minimal extra manufacturing cost.

Referring to FIGS. 3 to 6, an assembly 90 for separating particles of the first fluid out of a flow of the second fluid comprises a separation housing 100 defining a separation chamber 102. A plurality of ribs 104 are formed along a wall of the separation chamber 102. The ribs define grooves 106 there between. Coalescing apparatuses 50 and 150 are mounted in the assembly in an interference fit between resilient tabs 108 and grooves 110. This positions outlets 62 and 162 to direct fluid flow and therefore coalesced fluid particles in a gas flow against ribs 104.

It has been found that the ribs tend to hold coalesced fluid droplets in grooves 106 which build up to form a coating of fluid. This has been found to increase the ability of the ribs 104 to hold fluid particles. A flow of the second fluid from which droplets of the first fluid have been removed travels through the separation chamber 102 and exits through tube 112.

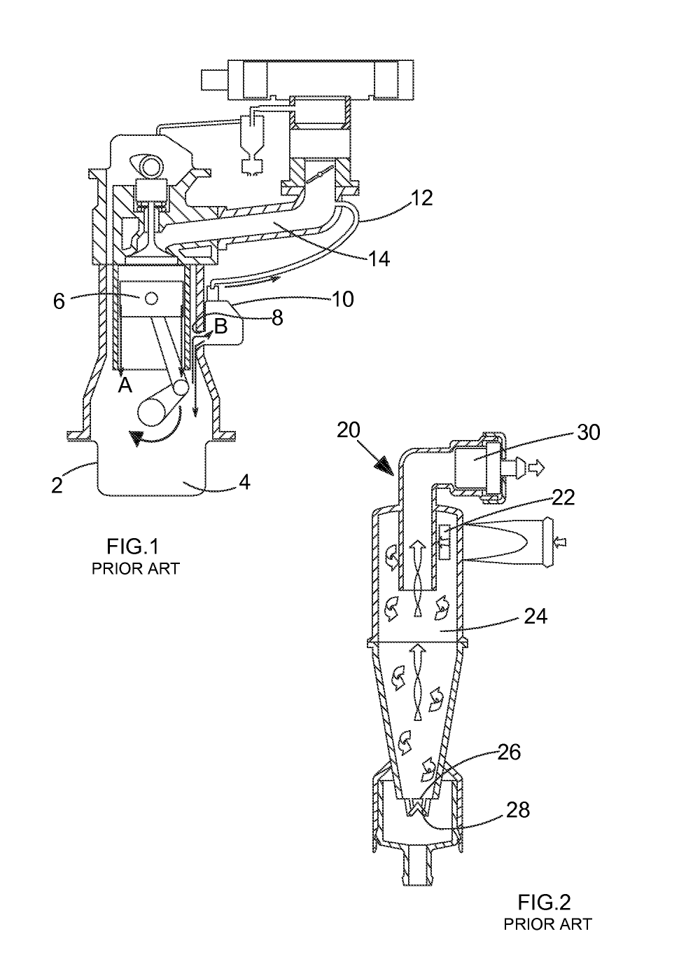

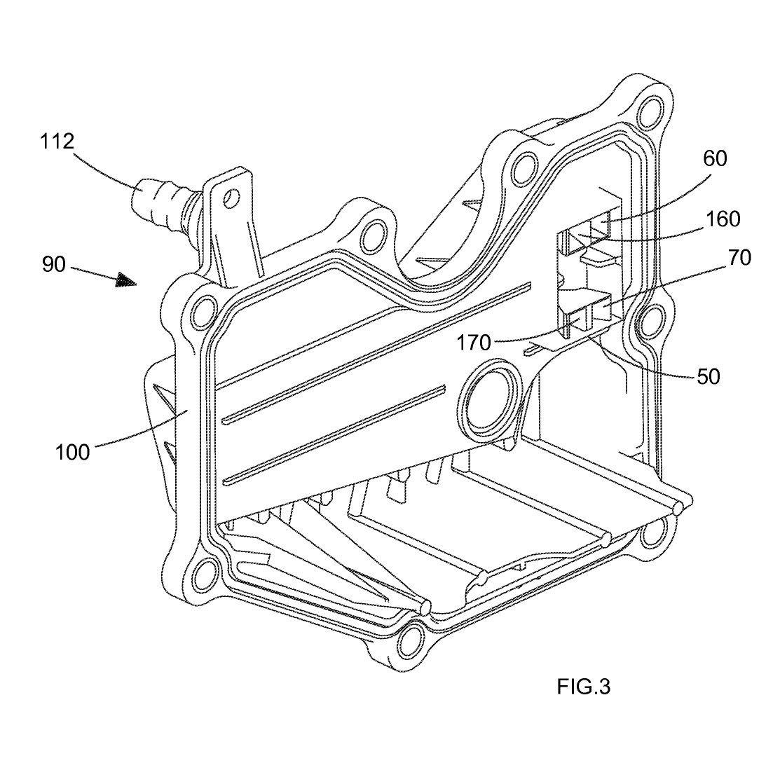

The operation of the assembly 90 incorporating apparatuses 50 and 150 for separating a first fluid from a flow of a second fluid, wherein the first fluid is denser than the second fluid, will now be described. In particular, the operation of assembly 90 for use as an oil separator in an internal combustion engine to separate oil from a flow of air and other gases will be described. In this regard, assembly 90 shown in FIG. 3 substantially performs and improves on the function of oil separator chamber 10 shown in FIG. 1.

Referring to FIGS. 3 to 6, blow-by gases entering the crank chamber of an internal combustion engine (parts of which are not shown) generally comprise a mixture of air and oil as well as by-products from the combustion process in the cylinders of the engine. This mixture of fluids increases the pressure in the crank case which forces gas into fluid inlet ducts 60, 70, 160 and 170. The fluid entering the inlet ducts is then caused to spiral inside enclosures 54 and 154 along the curved walls 56 and 156. This deposits oil droplets on the curved walls 56 and 156 which are blown around by gas flow to outlets 62 and 162. The outlets therefore blow out coalesced droplets of oil against ribs 104 formed on the internal walls of the separation chamber 102.

Grooves 104 formed between ribs 106 trap droplets of oil which slowly build up and form a coating of oil across the ribs. This creates an adhesive surface which helps to hold further drops of oil blowing against ribs 104. Consequently, air that has been cleaned of oil is able to circulate through separation chamber 102 and exit tube 112 to be fed back into the inlet manifold of the engine to be re-used in combustion. The collected oil is then returned to the oil sump for re-use.

Assembly 90 has been found to provide the following advantages:

i) It coalesces particles of oil in blow-by gases having a size of approximately 1 micron into larger droplets;

ii) It requires no servicing, i.e. it does not require the changing of filters;

iii) It causes a minimum pressure drop to minimise the risk of excessive crank case pressure;

iv) It requires no power from the engine to cause separation;

v) It has predictable performance to minimise engine development time and cost;

vi) It is scalable to suit engines of different sizes and power outputs;

vii) It can be packaged easily into cam covers and other engine components; and

viii) It is straightforward to manufacture from typical thermoplastics used in engine components.

It will be appreciated by persons skilled in the art that the above embodiments have been described by way of example only and not in any limitative sense, and that various alterations and modifications are possible without departure from the scope of the invention as defined by the appended claims. For example, the apparatus can be used with any type of liquid particle dispersed in any type of gas.

I claim:

1. An apparatus for coalescing particles of a first fluid entrained in a flow of a second fluid, wherein the first fluid has a higher density than the second fluid, the apparatus comprising:
a housing;
an enclosure formed in the housing, the enclosure defining a longitudinal axis and having at least one curved wall arranged to direct fluid flow along at least one said curved wall in a curved path;
a first inlet duct to the enclosure provided at a first location along the longitudinal axis for enabling introduction of a fluid flow substantially along a tangent to at least one said curved wall, the first inlet duct defining a first channel along which fluid flow is directed, the first channel having a decreasing cross sectional area along the direction of fluid flow;
an outlet from the enclosure provided at a second location along the longitudinal axis, remote from the first location, for enabling exit of the fluid flow substantially along a tangent to at least one said curved wall, wherein the enclosure is arranged to direct fluid flow along the at least one curved wall between an end of the first inlet duct disposed in the enclosure and the outlet to cause particles of the first fluid to coalesce and exit the outlet.

2. An apparatus according to claim 1, further comprising:
a second inlet duct to the enclosure provided at a third location along the longitudinal axis for enabling introduction of a fluid flow substantially along a tangent to at least one said curved wall, the second inlet duct defining a second channel along which fluid flow is directed, the second channel having a decreasing cross sectional area along the direction of fluid flow;
wherein the outlet from the enclosure is provided at the second location along the longitudinal axis for exit of all fluid flowing in the enclosure substantially along a tangent to at least one said curved wall and the second location is between the first and third locations; and
wherein the enclosure is arranged to direct fluid flow along the at least one curved wall between the end of the first inlet duct disposed in the enclosure and the outlet and an end of the second inlet duct disposed in the enclosure and the outlet to cause particles of the first fluid to coalesce and exit the outlet.

3. An apparatus according to claim 2, wherein the outlet is located at the mid-point between the ends of the first and second inlet ducts disposed in the enclosure along the first longitudinal axis.

4. An apparatus according to claim 1, wherein a portion of at least one said curved wall is substantially cylindrical.

5. An apparatus according to claim 1, wherein said outlet is arranged tangentially in the direction of fluid flow along said curved wall.

6. An apparatus for coalescing particles of a first fluid entrained in a flow of a second fluid, wherein the first fluid has a higher density than the second fluid, the apparatus comprising a first apparatus according to claim 1 mounted back-to-back with a second apparatus according to claim 1.

7. An assembly for separating particles of a first fluid entrained in a flow of a second fluid out of the flow of the second fluid, wherein the first fluid has a higher density than the second fluid, the assembly comprising:
a separation housing defining a separation chamber;
a plurality of ribs formed along a wall of said separation chamber; and
an apparatus according to claim 1 arranged such that the outlet of the apparatus directs coalesced particles of the first fluid entrained in fluid flow of the second fluid to enter the separation chamber and impinge on the edges of said plurality of ribs to cause particles of said first fluid to be held between said plurality of ribs and be removed from said fluid flow of the second fluid.

8. An apparatus for separating particles of a first fluid entrained in a flow of a second fluid out of the flow of the second fluid, wherein the first fluid has a higher density than the second fluid, the apparatus comprising:
a separation housing defining a separation chamber; and
a plurality of ribs formed along a wall of said separation chamber, wherein said plurality of ribs is arranged such that coalesced particles of the first fluid entrained in fluid flow of the second fluid impinging on the edges of said plurality of ribs causes particles of said first fluid to be held between said plurality of ribs and be removed from the fluid flow of the second fluid.
